(19) United States
(12) Patent Application Publication
(10) Pub. No.: US 2026/0065158 A1
(43) Pub. Date: Mar. 5, 2026

(54) METHODS, APPARATUSES AND COMPUTER PROGRAM PRODUCTS TO FACILITATE STREAMING PROCESSING OF LARGE LANGUAGE MODEL INPUTS

(71) Applicant: META PLATFORMS, INC., Menlo Park, CA (US)

(72) Inventors: Frank Torsten Bernd Seide, Yarrow Point, WA (US); Yangyang Shi, Bellevue, WA (US)

(21) Appl. No.: 19/311,811

(22) Filed: Aug. 27, 2025

Related U.S. Application Data
(60) Provisional application No. 63/689,041, filed on Aug. 30, 2024.

(51) Int. Cl. G06N 20/00; G06F 40/284

(52) U.S. Cl. CPC G06N 20/00; G06F 40/284

(57) ABSTRACT

A system and method to train a large language model are provided. The system may access training data including one or more events and including one or more frames of a fixed duration. The system may further generate a label sequence based on the training data, and the system may determine an interleaved embedding sequence from the label sequence. The system may further determine a probability distribution over one or more predicted tokens based at least in part on an embedding of the interleaved embedding sequence. The system may further determine a difference between the probability distribution over the one or more predicted tokens and the label sequence. The system may further modify one or more parameters of the large language model based on the determined difference.

### CROSS-REFERENCE TO RELATED APPLICATIONS

This application claims the benefit of U.S. Provisional Application No. 63/689,041, filed Aug. 30, 2024, and titled “STREAMING PROCESSING WITH MULTI-MODAL MODELS,” the entire content of which is incorporated herein by reference.

### TECHNOLOGICAL FIELD

Examples of the present disclosure relate generally to methods, devices, and computer program products to facilitate real-time streaming processing with multi-modal models, such as large language models.

### BACKGROUND

In recent years, the development of large language models (LLMs) has revolutionized natural language processing, enabling sophisticated applications in text generation, translation, and summarization. Despite these advancements, current LLMs are typically still not designed to process information in real time. Instead, these current/existing LLMs typically operate in a turn-based manner, requiring the user to input a complete prompt (or other set of data) before generating a response. This reactive approach may restrict the applicability of LLMs in scenarios involving continuous and immediate interaction with dynamic inputs. For instance, real-time transcription, acoustic event detection, and interactive natural dialogues may require a system that may process and respond to data as it is received, rather than after an entire segment has been input.

The lack of real-time capabilities in LLMs presents a gap in their utility for numerous applications that involve ongoing engagement with streaming data. Methods such as Recurrent Neural Network Transducers (RNN-T) and Attention-Encoder-Decoder (AED) models attempt real-time processing but involve complex architectures and training procedures. Therefore, there is a need for a more flexible and efficient approach to real-time data processing with LLMs.

### BRIEF SUMMARY

Some examples of the present disclosure may be directed to a machine learning model (e.g., a trained or fine-tuned large language model) that may continuously process incoming speech data and generate corresponding text in real-time. In some examples, the machine learning model may invoke a generation loop after each received token, thereby allowing for immediate interaction and continuous engagement with dynamic inputs.

Some exemplary aspects of the present disclosure may provide a machine learning model in the form of a streaming LLM that may perform speech processing tasks (e.g., automatic speech recognition (ASR)). The machine learning model may utilize input data (e.g., text, video, and/or audio) embedded as a sequence of tokens (e.g., words, sub-words, and/or periods of silence). The machine learning model may use the embedded sequence information along with previously generated (e.g., predicted) tokens to generate the next token (e.g., a word or sub-word) in the sequence. Additionally, the machine learning model may output tokens on a streaming basis (e.g., without first receiving the entire input) and may further be fine-tuned to learn and reproduce the flow of time (e.g., via the outputting of BLANK symbols representing periods of silence to control the flow of the output). In this regard, the exemplary aspects of the present disclosure may enable real-time transcription of speech by generating text as the speech is being spoken, rather than waiting for complete utterances or regenerating the tokens as new data is received.

In one example of the present disclosure, a method is provided. The method may include accessing training data by a machine learning model. The training data may include one or more events as well as one or more frames of a fixed duration. The method may further include generating a label sequence based on the training data. The method may further include determining an interleaved embedding sequence from the label sequence. The method may further include determining a probability distribution over one or more predicted tokens based at least in part on an embedding of the interleaved embedding sequence. The method may further include determining a difference between the probability distribution over the one or more predicted tokens and the label sequence. The method may further include modifying one or more parameters of the machine learning model based on the determined difference between the predicted token and the label sequence.

In another example of the present disclosure, an apparatus. The apparatus may include one or more processors and a memory including computer program code instructions. The memory and computer program code instructions are configured to, with at least one of the processors, cause the apparatus to at least perform operations including accessing training data by a machine learning model. The training data may include one or more events as well as one or more frames of a fixed duration. The memory and computer program code are also configured to, with the processor(s), cause the apparatus to generate a label sequence based on the training data. The memory and computer program code are also configured to, with the processor(s), cause the apparatus to determine an interleaved embedding sequence from the label sequence. The memory and computer program code are also configured to, with the processor(s), cause the apparatus to determine a probability distribution over one or more predicted tokens based at least in part on an embedding of the interleaved embedding sequence. The memory and computer program code are also configured to, with the processor(s), cause the apparatus to determine a difference between the probability distribution over the one or more predicted tokens and the label sequence. The memory and computer program code are also configured to, with the processor(s), cause the apparatus to modify one or more parameters of the machine learning model based on the determined difference between the predicted token and the label sequence.

In yet another example of the present disclosure, a computer program product is provided. The computer program product may include at least one non-transitory computer-readable medium including computer-executable program code instructions stored therein. The computer-executable program code instructions may include program code instructions configured to access training data by a machine learning model. The training data may include one or more events as well as one or more frames of a fixed duration. The computer program product may further include program code instructions configured to generate a label sequence based on the training data. The computer program product may further include program code instructions configured to determine an interleaved embedding sequence from the label sequence. The computer program product may further include program code instructions configured to determine a probability distribution over one or more predicted tokens based at least in part on an embedding of the interleaved embedding sequence. The computer program product may further include program code instructions configured to determine a difference between the probability distribution over the one or more predicted tokens and the label sequence. The computer program product may further include program code instructions configured to modify one or more parameters of the machine learning model based on the determined difference between the predicted token and the label sequence.

Additional advantages will be set forth in part in the description that follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The summary, as well as the following detailed description, is further understood when read in conjunction with the appended drawings. For the purpose of illustrating the disclosed subject matter, examples of the disclosed subject matter are shown in the drawings; however, the disclosed subject matter is not limited to the specific methods, compositions, and devices disclosed. In addition, the drawings are not necessarily drawn to scale. In the drawings:

FIG. 1 illustrates a diagram of an exemplary network environment, in accordance with an example of the present disclosure.

FIG. 2 illustrates a diagram of an exemplary communication device, in accordance with an example of the present disclosure.

FIG. 3 illustrates an exemplary computing system, in accordance with an example of the present disclosure.

FIG. 4 illustrates a machine learning and training model framework, in accordance with example aspects of the present disclosure.

FIG. 5 illustrates an example process for generating a training target sequence from a training utterance, in accordance with an example of the present disclosure.

FIG. 6 illustrates an example architecture for processing speech and token, embeddings, in accordance with an example of the present disclosure.

FIG. 7 illustrates an example flowchart illustrating operations for training a machine learning model in accordance with an example of the present disclosure.

The FIGURES depict various examples for purposes of illustration only. One skilled in the art will readily recognize from the following discussion that alternative examples of the structures and methods illustrated herein may be employed without departing from the principles described herein.

### DETAILED DESCRIPTION

Some examples of the present disclosure will now be described more fully hereinafter with reference to the accompanying drawings, in which some, but not all examples of the present disclosure are shown. Indeed, various examples of the present disclosure may be embodied in many different forms and should not be construed as limited to the examples set forth herein. Like reference numerals refer to like elements throughout.

As used herein, the terms “data,” “content,” “information,” and similar terms may be used interchangeably to refer to data capable of being transmitted, received and/or stored in accordance with examples of the disclosure. Moreover, the term “exemplary,” as used herein, is not provided to convey any qualitative assessment, but instead merely to convey an illustration of an example. Thus, use of any such terms should not be taken to limit the spirit and scope of examples of the disclosure.

As defined herein, a “computer-readable storage medium,” which refers to a non-transitory, physical or tangible storage medium (e.g., volatile or non-volatile memory device), may be differentiated from a “computer-readable transmission medium,” which refers to an electromagnetic signal.

As referred to herein, an “application” may refer to a computer software package that may perform specific functions for users and/or, in some cases, for another application(s). An application(s) may utilize an operating system (OS) and other supporting programs to function. In some examples, an application(s) may request one or more services from, and communicate with, other entities via an application programming interface (API).

As referred to herein, a resource(s), or an external resource(s) may refer to any entity or source that may be accessed by a program or system that may be running, executed or implemented on a communication device and/or a network. Some examples of resources may include, but are not limited to, HyperText Markup Language (HTML) pages, web pages, images, videos, scripts, stylesheets, other types of files (e.g., multimedia files) that may be accessible via a network (e.g., the Internet) as well as other files that may be locally stored and/or accessed by communication devices.

It is to be understood that the methods and systems described herein are not limited to specific methods, specific components, or to particular implementations. It is also to be understood that the terminology used herein is for the purpose of describing particular embodiments only and is not intended to be limiting.

### Exemplary System Architecture

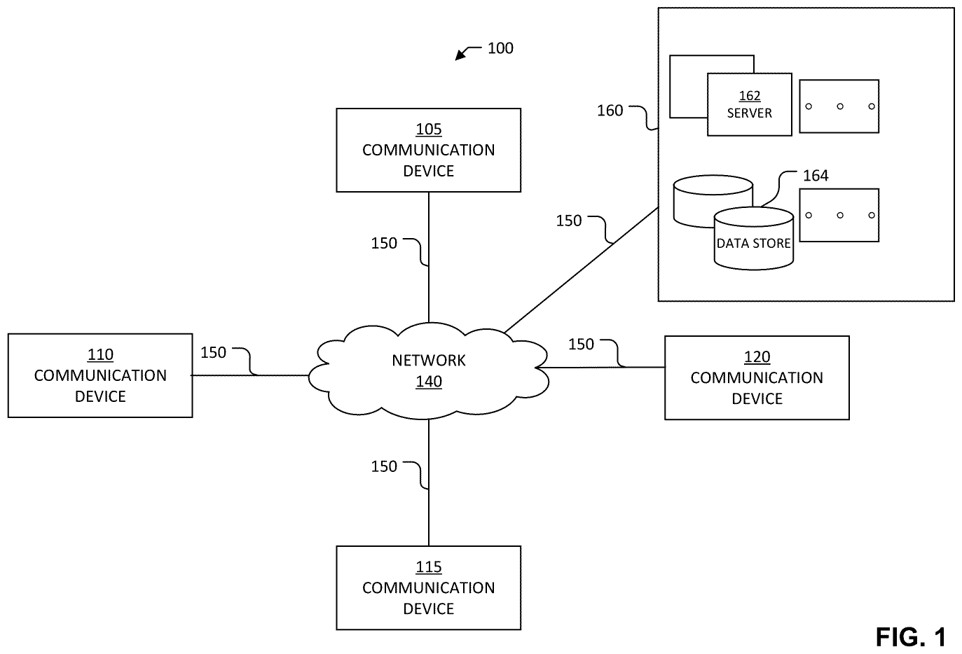

Reference is now made to FIG. 1, which is a block diagram of a system according to exemplary embodiments. As shown in FIG. 1, the system 100 may include one or more communication devices 105, 110, 115 and 120 and a network device 160. Additionally, the system 100 may include any suitable network such as, for example, network 140. In some examples, the network 140. In other examples, the network 140 may be any suitable network capable of provisioning content and/or facilitating communications among entities within, or associated with the network 140. As an example and not by way of limitation, one or more portions of network 140 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 140 may include one or more networks 140.

Links 150 may connect the communication devices 105, 110, 115 and 120 to network 140, network device 160 and/or to each other. This disclosure contemplates any suitable links 150. In some exemplary embodiments, one or more links 150 may include one or more wired and/or wireless links, such as, for example, Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH). In some exemplary embodiments, one or more links 150 may each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout system 100. One or more first links 150 may differ in one or more respects from one or more second links 150.

In some exemplary embodiments, communication devices 105, 110, 115, 120 may be electronic devices including hardware, software, or embedded logic components or a combination of two or more such components and capable of carrying out the appropriate functionalities implemented or supported by the communication devices 105, 110, 115, 120. As an example, and not by way of limitation, the communication devices 105, 110, 115, 120 may be a computer system such as, for example, a desktop computer, notebook or laptop computer, netbook, a tablet computer (e.g., a smart tablet), e-book reader, Global Positioning System (GPS) device, camera, personal digital assistant (PDA), handheld electronic device, cellular telephone, smartphone, smart glasses, augmented/virtual reality device, smart watches, charging case, or any other suitable electronic device, or any suitable combination thereof. The communication devices 105, 110, 115, 120 may enable one or more users to access network 140. The communication devices 105, 110, 115, 120 may enable a user(s) to communicate with other users at other communication devices 105, 110, 115, 120. For example, communication devices 105, 110, 115, 120 may be participating in a messaging thread involving the exchange of messages created by respective user input.

Network device 160 may be accessed by the other components of system 100 either directly or via network 140. As an example and not by way of limitation, communication devices 105, 110, 115, 120 may access network device 160 using a web browser or a native application associated with network device 160 (e.g., a mobile social-networking application, a messaging application, another suitable application, or any combination thereof) either directly or via network 140. In particular exemplary embodiments, network device 160 may include one or more servers 162. Each server 162 may be a unitary server or a distributed server spanning multiple computers or multiple datacenters. Servers 162 may be of various types, such as, for example and without limitation, web server, news server, mail server, message server, advertising server, file server, application server, exchange server, database server, proxy server, another server suitable for performing functions or processes described herein, or any combination thereof. In particular exemplary embodiments, each server 162 may include hardware, software, or embedded logic components or a combination of two or more such components for carrying out the appropriate functionalities implemented and/or supported by server 162. In particular exemplary embodiments, network device 160 may include one or more data stores 164. Data stores 164 may be used to store various types of information. In particular exemplary embodiments, the information stored in data stores 164 may be organized according to specific data structures. In particular exemplary embodiments, each data store 164 may be a relational, columnar, correlation, or other suitable database. Although this disclosure describes or illustrates particular types of databases, this disclosure contemplates any suitable types of databases. Particular exemplary embodiments may provide interfaces that enable communication devices 105, 110, 115, 120 and/or another system (e.g., a third-party system) to manage, retrieve, modify, add, or delete, the information stored in data store 164. For example, a server 162 may facilitate training a machine learning model (e.g., an LLM) for use by one or more of the communication devices 105, 110, 115, 120.

Network device 160 may provide users of the system 100 the ability to communicate and interact with other users. In particular exemplary embodiments, network device 160 may provide users with the ability to take actions on various types of items or objects, supported by network device 160. In particular exemplary embodiments, network device 160 may be capable of linking a variety of entities. As an example and not by way of limitation, network device 160 may enable users to interact with each other as well as receive content from other systems (e.g., third-party systems) or other entities, or allow users to interact with these entities through an application programming interface (API) or other communication channels.

It should be pointed out that although FIG. 1 shows one network device 160 and four communication devices 105, 110, 115 and 120, any suitable number of network devices 160 and communication devices 105, 110, 115 and 120 may be part of the system of FIG. 1 without departing from the spirit and scope of the present disclosure.

### Exemplary Communication Device

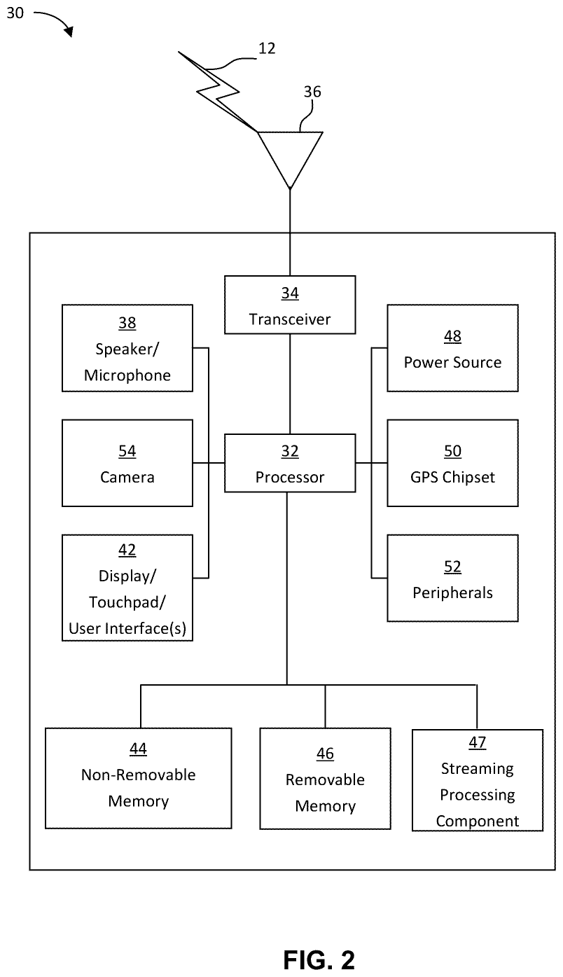

FIG. 2 illustrates a block diagram of an exemplary hardware/software architecture of a communication device such as, for example, user equipment (UE) 30. In some exemplary respects, the UE 30 may be any of communication devices 105, 110, 115, 120. In some exemplary aspects, the UE 30 may be a computer system such as, for example, a desktop computer, notebook or laptop computer, netbook, a tablet computer (e.g., a smart tablet), e-book reader, GPS device, camera, personal digital assistant, handheld electronic device, cellular telephone, smartphone, smart glasses, augmented/virtual reality device, smart watch, charging case, or any other suitable electronic device. As shown in FIG. 2, the UE 30 (also referred to herein as node 30) may include a processor 32, non-removable memory 44, removable memory 46, a speaker/microphone 38, a display, touchpad, and/or user interface(s) 42, a power source 48, a GPS chipset 50, and other peripherals 52. In some exemplary aspects, the display, touchpad, and/or user interface(s) 42 may be referred to herein as display/touchpad/user interface(s) 42. The display/touchpad/user interface(s) 42 may include a user interface capable of presenting one or more content items and/or capturing input of one or more user interactions/actions associated with the user interface. The power source 48 may be capable of receiving electric power for supplying electric power to the UE 30. For example, the power source 48 may include an alternating current to direct current (AC-to-DC) converter allowing the power source 48 to be connected/plugged to an AC electrical receptacle and/or Universal Serial Bus (USB) port for receiving electric power. The UE 30 may also include a camera 54. In an exemplary embodiment, the camera 54 may be a smart camera configured to sense images/video appearing within one or more bounding boxes. The UE 30 may also include communication circuitry, such as a transceiver 34 and a transmit/receive element 36. It will be appreciated that the UE 30 may include any sub-combination of the foregoing elements while remaining consistent with an embodiment.

The processor 32 may be a special purpose processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 32 may execute computer-executable instructions stored in the memory (e.g., non-removable memory 44 and/or removable memory 46) of the node 30 in order to perform the various required functions of the node. For example, the processor 32 may perform signal coding, data processing, power control, input/output processing, and/or any other functionality that enables the node 30 to operate in a wireless or wired environment. The processor 32 may run application layer programs (e.g., browsers) and/or radio access-layer (RAN) programs and/or other communications programs. The processor 32 may also perform security operations such as authentication, security key agreement, and/or cryptographic operations, such as at the access-layer and/or application layer for example. The non-removable memory 44 and/or the removable memory 46 may be computer-readable storage mediums. For example, the non-removable memory 44 may include a non-transitory computer-readable storage medium and a transitory computer-readable storage medium.

The processor 32 is coupled to its communication circuitry (e.g., transceiver 34 and transmit/receive element 36). The processor 32, through the execution of computer-executable instructions, may control the communication circuitry in order to cause the node 30 to communicate with other nodes via the network to which it is connected.

The transmit/receive element 36 may be configured to transmit signals to, or receive signals from, other nodes or networking equipment. For example, in an exemplary embodiment, the transmit/receive element 36 may be an antenna configured to transmit and/or receive radio frequency (RF) signals. The transmit/receive element 36 may support various networks and air interfaces, such as wireless local area network (WLAN), wireless personal area network (WPAN), cellular, and the like. In yet another exemplary embodiment, the transmit/receive element 36 may be configured to transmit and/or receive both RF and light signals. It will be appreciated that the transmit/receive element 36 may be configured to transmit and/or receive any combination of wireless or wired signals.

The transceiver 34 may be configured to modulate the signals that are to be transmitted by the transmit/receive element 36 and to demodulate the signals that are received by the transmit/receive element 36. As noted above, the node 30 may have multi-mode capabilities. Thus, the transceiver 34 may include multiple transceivers for enabling the node 30 to communicate via multiple radio access technologies (RATs), such as universal terrestrial radio access (UTRA) and Institute of Electrical and Electronics Engineers (IEEE 802.11), for example.

The processor 32 may access information from, and store data in, any type of suitable memory, such as the non-removable memory 44 and/or the removable memory 46. For example, the processor 32 may store message thread context in its memory (e.g., non-removable memory 44 and/or removable memory 46). The non-removable memory 44 may include RAM, ROM, a hard disk, or any other type of memory storage device. The removable memory 46 may include a subscriber identity module (SIM) card, a memory stick, a secure digital (SD) memory card, and the like. In other exemplary embodiments, the processor 32 may access information from, and store data in, memory that is not physically located on the node 30, such as on a server or a home computer.

The processor 32 may receive power from the power source 48 and may be configured to distribute and/or control the power to the other components in the node 30. The power source 48 may be any suitable device for powering the node 30. For example, the power source 48 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like. The processor 32 may also be coupled to the GPS chipset 50, which may be configured to provide location information (e.g., longitude and latitude) regarding the current location of the node 30. It will be appreciated that the node 30 may acquire location information by way of any suitable location-determination method while remaining consistent with an exemplary embodiment.

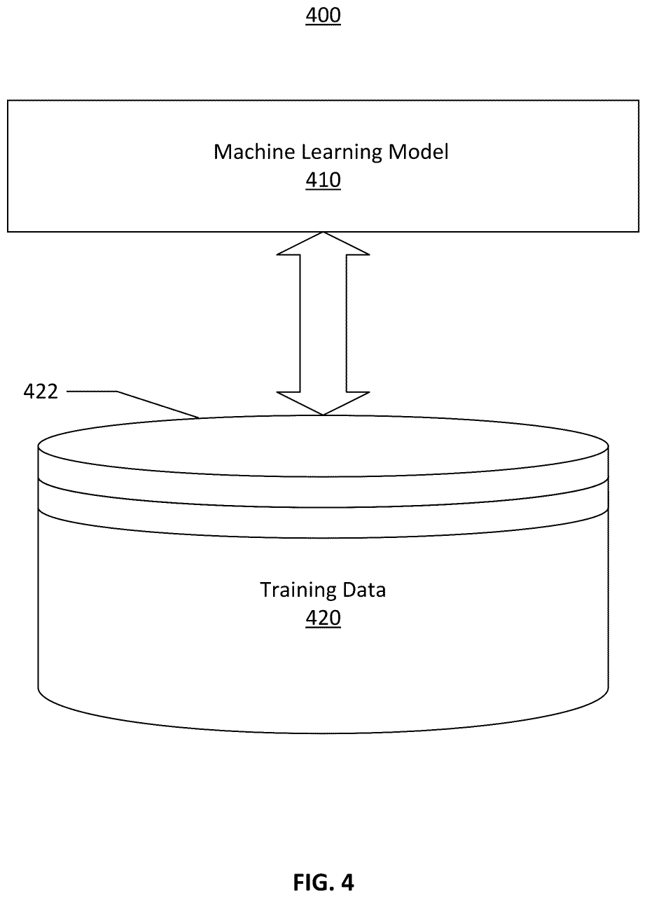

The UE 30 may also include a streaming processing component 47 that may continuously process streaming input data (e.g., speech data) and generate corresponding text in real-time. In some examples, the streaming processing component 47 may implement a machine learning model (e.g., machine learning model 410 of FIG. 4) that may invoke a generation loop after each received token, thereby allowing for immediate interaction and continuous engagement with dynamic inputs, as described more fully below.

### Exemplary Computing System

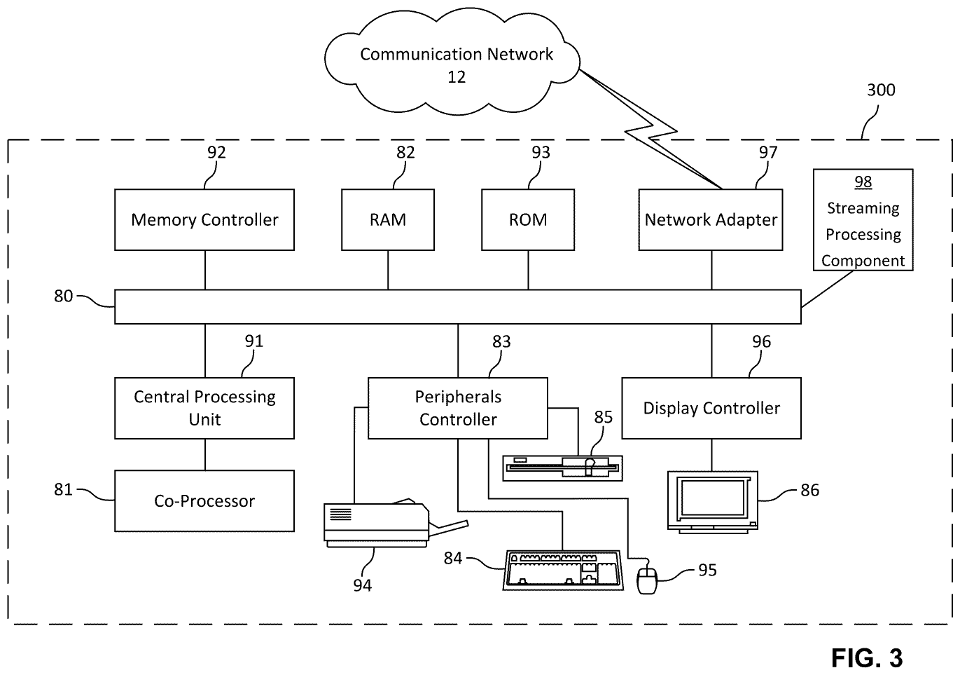

FIG. 3 is a block diagram of an exemplary computing system 300. In some exemplary embodiments, the network device 160 may be a computing system 300. The computing system 300 may comprise a computer or server and may be controlled primarily by computer-readable instructions, which may be in the form of software, wherever, or by whatever means such software is stored or accessed. Such computer-readable instructions may be executed within a processor, such as central processing unit (CPU) 91, to cause computing system 300 to operate. In many workstations, servers, and personal computers, central processing unit 91 may be implemented by a single-chip CPU called a microprocessor. In other machines, the central processing unit 91 may comprise multiple processors. Coprocessor 81 may be an optional processor, distinct from main CPU 91, that performs additional functions or assists CPU 91.

In operation, CPU 91 fetches, decodes, and executes instructions, and transfers information to and from other resources via the computer's main data-transfer path, system bus 80. Such a system bus connects the components in computing system 300 and defines the medium for data exchange. System bus 80 typically includes data lines for sending data, address lines for sending addresses, and control lines for sending interrupts and for operating the system bus. An example of such a system bus 80 is the Peripheral Component Interconnect (PCI) bus. The computing system 300 may also include a streaming processing component 98 that may continuously process streaming input data (e.g., speech data) and generate corresponding text in real-time. The streaming processing component 98 may facilitate presentation of the streaming input data and/or the corresponding text via display 86. In some examples, the streaming processing component 98 may implement a machine learning model (e.g., machine learning model 410 of FIG. 4) that may invoke a generation loop after each received token, thereby allowing for immediate interaction and continuous engagement with dynamic inputs, as described more fully below.

In some examples, the streaming processing component 98 may continuously process streaming input data (e.g., speech data) and generate corresponding text in real-time in response to determining or receiving content input by, or associated with, one or more users (e.g., a user or a set/group of users, e.g., users in a group communication). The input may be input content or captured content by one or more user interfaces (e.g., display/touchpad/user interface(s) 42) of one or more communication devices (e.g., UEs 30). For instance, in some examples, the streaming processing component 47 may provide the content input to (or captured by) a user interface(s), by or associated with a user(s), to the streaming processing component 98 of the computer system 300. The providing of the content input to or captured by the user interface by the streaming processing component 47 to the streaming processing component 98 may enable the streaming processing component 98 to generate text in real-time. In some aspects of the present disclosure, the streaming processing component 98 may provide the generated text to one or more communication devices (e.g., UEs 30), which may present the generated text via a user interface and/or a display (e.g., display/touchpad/user interface(s) 42).

Additionally, as described more fully below, in some examples of the present disclosure determined topics/subjects of communications may be utilized as an input(s) to a machine learning model (e.g., machine learning model(s) 410) which the streaming processing component 98 may implement to perform continuously processing streaming input data (e.g., speech data) and generating corresponding text in real-time.

Memories coupled to system bus 80 include RAM 82 and ROM 93. Such memories may include circuitry that allows information to be stored and retrieved. ROMs 93 generally contain stored data that cannot easily be modified. Data stored in RAM 82 may be read or changed by CPU 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 300 may contain peripherals controller 83 responsible for communicating instructions from CPU 91 to peripherals, such as printer 94, keyboard 84, mouse 95, and disk drive 85.

Display 86, which is controlled by display controller 96, may be used to display visual output generated by computing system 300. Such visual output may include text, graphics, animated graphics, and video. The display 86 may also include or be associated with a user interface. The user interface may be capable of presenting one or more content items and/or capturing input of one or more user interactions associated with the user interface. Display 86 may be implemented with a cathode-ray tube (CRT)-based video display, a liquid-crystal display (LCD)-based flat-panel display, gas plasma-based flat-panel display, or a touch-panel. Display controller 96 includes electronic components required to generate a video signal that is sent to display 86.

Further, computing system 300 may contain communication circuitry, such as for example a network adapter 97, that may be used to connect computing system 300 to an external communications network, such as network 12 of FIG. 2, to enable the computing system 300 to communicate with other nodes (e.g., UE 30) of the network.

### Exemplary Machine Learning Model

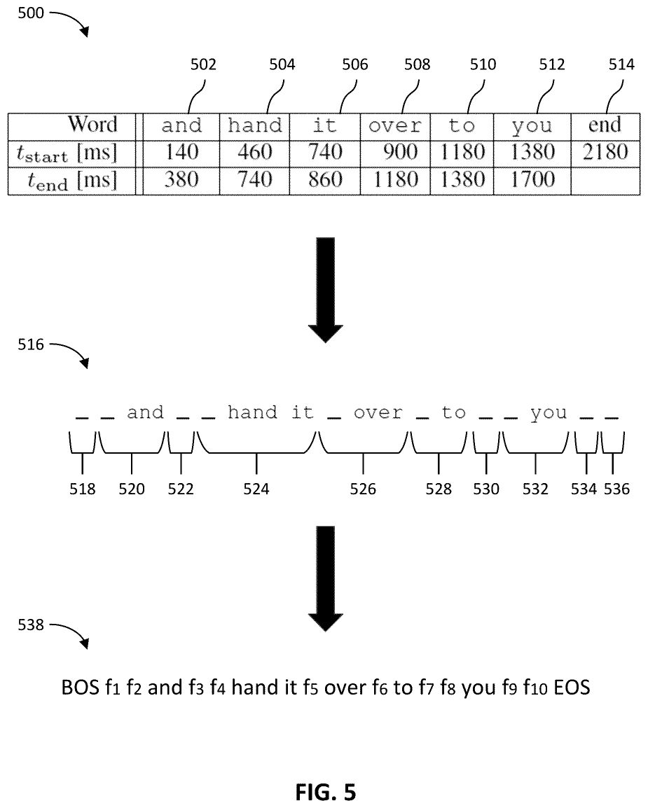

FIG. 4 illustrates a machine learning framework 400, in accordance with an example of the present disclosure. The machine learning framework 400 associated with the machine learning model 410 may be hosted remotely. Alternatively, the machine learning framework 400 may reside within a server 162 shown in FIG. 1 and/or within an electronic device (e.g., head mounted displays, smartphones, tablets, smartwatches, or any electronic device, such as communication device 105). In some examples, the machine learning model 410 may be associated with operations of FIGS. 5, 6 and 7. The machine learning model 410 may be implemented by one or more machine learning models(s). In some embodiments, the machine learning model 410 may be a student model trained by a teacher model, and the teacher model may be included in the training database 422.

The machine learning model 410 may be communicatively coupled to the stored training data 420 in a memory or database (e.g., ROM, RAM), such as training database 422. The training data 420 may encompass a wide range of training samples of audio data, including speech, dialogues, and various environmental sounds. Each training sample may be an audio stream. Additionally, or alternatively, each sample may be segmented into small chunks (e.g., 80 milliseconds (ms), 240 ms, etc.) to simulate a real-time audio stream, allowing the machine learning model 410 to learn how to process and respond to input incrementally. Additionally, the training data 420 may include transcripts or labels corresponding to audio events (e.g., words, sub-words, or other sounds) to provide a supervised learning framework, helping the machine learning model 410 understand the relationship between the audio inputs and their textual representations. This variety may help the machine learning model 410 generalize to different scenarios, from transcribing live speech to detecting specific acoustic events.

In some examples, the training data 420 associated with the machine learning model 410 may also or instead include multi-modal inputs such as video feeds, sensor data, and/or other streaming information sources (or other data that may be modified to simulate streaming information sources). For instance, video data paired with captions or descriptions may enable the machine learning model 410 to understand and generate responses to visual events in real-time. Similarly, sensor data from wearable devices or home security systems, labeled with relevant events or states, may enable the machine learning model 410 to monitor and respond to changes dynamically.

One approach to train the machine learning model 410 may be supervised learning, where the machine learning model 410 may be trained on text data paired with labels and/or target outputs. During training, the machine learning model 410 may learn to predict the next token (e.g., word or sub-word) in a sequence, given the preceding context, by minimizing the difference between its predictions and the actual target tokens in the training data. The learning may occur via techniques called back-propagation and/or gradient descent. Back-propagation may involve determining the gradient of the loss function, which measures the prediction error of the machine learning model 410 with respect to each parameter(s). Gradient descent may then use the gradients to adjust the parameters in the direction that reduces the prediction error, such as through an optimization algorithm/application like stochastic gradient descent (SGD). This iterative process may allow the machine learning model 410 to gradually improve its performance by learning from its mistakes. Additionally, techniques such as dropout and regularization may be employed to prevent over-fitting such that the machine learning model 410 generalizes well to new, unseen data. Other methods, such as transfer learning and fine-tuning, may be used to adapt pre-trained models to specific tasks or domains, leveraging the knowledge gained from large-scale pre-training to enhance performance on more specialized applications.

Beyond supervised learning and back-propagation, other training algorithms/applications may be employed for training. One such method is unsupervised learning, where the machine learning model 410 may be trained on unlabeled data, learning to recognize patterns and structures within the text without explicit target outputs. Self-supervised learning is a related approach, where the machine learning model 410 may generate its own labels from the input data, such as predicting missing words in a sentence. Reinforcement learning may also be used, where the machine learning model 410 may be trained to make sequences of decisions by receiving rewards or penalties based on the quality of its outputs, fostering the development of more coherent and contextually appropriate responses.

In some examples, the machine learning model 410 may be a decoder-only LLM. A decoder-only LLM may be a type of neural network transformer architecture that focuses on the generative aspect of language modeling, for example, without cross-attention into an encoder component (although an encoder component may still be present). In this setup, the machine learning model 410 may generate text by predicting the next token (e.g., word or sub-word) in a sequence based on the preceding tokens (e.g., words or sub-words), decoding the output from the input sequence. In other words, the machine learning model 410 may work by iteratively predicting and appending tokens to the sequence, leveraging self-attention mechanisms to understand the context provided by the previously generated tokens.

The machine learning model 410 may utilize a decoder that includes a stack of transformer decoder layers, and a multi-modal encoder that encodes input (e.g., speech data) into a sequence of embedding vectors used in place of and/or in combination with text embeddings.

The machine learning model 410 may utilize an encoder tailored to a particular application. For example, for automatic speech recognition (ASR), the encoder may be a streaming encoder, such as an Emformer, Conformer, or Streaming Conformer. In some examples, the encoder may be incorporated into a speech tokenizer. In one example, the speech tokenizer may include a fully causal speech encoder with a quantizer in the middle. The quantizer discretizes latent features of the encoder and its output corresponds to discrete speech tokens. The casual aspect of the tokenizer enables streaming real-time speech processing and may avoid information leakage from future speech frames, which may interact poorly with next token prediction (NTP). In some examples, the tokenizer may be trained utilizing a combination of losses (e.g., Chroma loss, CTC loss, and Mel reconstruction loss), thereby encouraging speech tokens to capture prosody, semantic, and fined-grained acoustic information. Losses may then be distributed into disparate layers to avoid loss contention and facilitate stable training. In one example, the tokenizer may operate on a time frame of ΔT=80 ms of speech for each of a number of time steps (e.g., eight stacked log Mel frames spanning T_{frame}=10 ms each). In this example, the tokenizer may have an output sampling rate of 12.5 Hz. The sampling rate may have several latency implications. For example, for each time step, an LLM would need to finish outputting all necessary tokens within ΔT in order to keep up with real-time processing. Additionally, a theoretical minimum user perceived system latency may be realized at ΔT or higher (e.g., due to network communication overhead, LLM inference cost, token-to-wave auxiliary modules, and various applied algorithmic delays in a speech-text hybrid model).

The machine learning model 410 may be a pre-trained LLM. That is, the machine learning model 410 may be pre-trained on a large corpus of text data to learn general language patterns, grammar, and context. Pre-training the machine learning model 410 may utilize unsupervised learning techniques, where the machine learning model 410 may learn to predict the next word or token in a sentence. For instance, the machine learning model 410 may be trained on datasets comprising books, articles, web pages, and other written materials that cover a wide range of topics and styles. During pre-training, the machine learning model 410 may process sequences of text and learn the statistical properties of language, such as grammar, syntax, and common phrases, by optimizing its ability to predict missing or next words in the sequences.

After pre-training, the machine learning model 410 may undergo fine-tuning with specific datasets tailored for particular applications such as real-time ASR. For example, during fine-tuning, the machine learning model 410 may be exposed to time-aligned audio data with corresponding transcripts, allowing it to learn how to handle streaming input effectively. Although a variety of real-time applications are contemplated, the following detailed description of the present disclosure is provided with respect to ASR as merely an example and not a limitation. The training data 420 may include data sets for training and/or for fine-tuning the machine learning model 410.

In some examples, a component (e.g., streaming processing component 47, streaming processing component 98) and/or a device (e.g., UE 30, computing system 300) may implement the machine learning model(s) 410 to continuously process streaming input data (e.g., speech data) and generate corresponding text in real-time. The generated text may include one or more alphanumeric characters. The alphanumeric characters may include, but are not limited to, alphabetic characters, numeric characters, punctuation, symbols and/or the like. In some examples, the training data 420 may be synthetic data, and/or content associated with a network (e.g., the Internet), as described above, such as, for example, content based on one or more web pages, and/or content based on attributes (e.g., posters, etc.) as described above. The machine learning framework 400 may take raw text such as, for example, written or captured text of a user input/captured by a composer, other content or media (e.g., multimedia content such as for example videos, pictures/images, etc.) as the input for the machine learning model 430, and a rendering visualization of the raw text, other content or media may be generated by the machine learning framework 400 as results (e.g., one or more labels) for/associated with the training data 420. The machine learning model 410 may be able to learn from the training data 420 (e.g., the input text, content, media) to predict or determine the output to render as one or more results.

### Exemplary System Operation

FIG. 5 illustrates an example process to generate a training target sequence 516 from a training utterance 500, in accordance with an example of the present disclosure. Not all of the depicted components may be used in all implementations, however, and one or more implementations may include additional or different components than those shown in FIG. 5. Variations in the arrangement and type of the components may be made without departing from the spirit or scope of the claims as set forth herein. Additional components, different components, or fewer components may be provided.

A streaming processing component (e.g., streaming processing component 47, streaming processing component 98) of a communication device (e.g., UE 30, computing system 30) may train (e.g., fine-tune) the machine learning model 410 for streaming applications. An aspect of the present disclosure includes training the machine learning model 410 to output a BLANK symbol when additional input is needed to generate an output (e.g., periods with no significant events such as silence). This way, the machine learning model 410 may effectively learn to reproduce the flow of time and operate proactively (e.g., in real time without the requirement of inputting a complete set of data before generating an output).

To train the machine learning model 410 to output a BLANK symbol when additional input is needed to generate an output, as in the case of ASR, may involve exposing the machine learning model 410 to time-aligned audio data. Time-aligned audio data may be audio data segmented into smaller chunks (e.g., 80 ms, 240 ms, etc.), each chunk associated with one or more tokens (e.g., word or sub-word labels) and/or a BLANK symbol (e.g., a blank label) from a transcription of the audio data (e.g., labeled audio data). An alignment teacher (e.g., an external connectionist temporal classification (CTC) model) may be utilized to generate precise alignments for each token (e.g., word or sub-word) in the training utterances (e.g., training data 420). These alignments may specify the start and/or end times for each token in the training utterances, which may help maintain temporal accuracy during streaming input processing. Consider the utterance “and hand it over to you” (e.g., tokens 502-514). The utterance 500 may be represented as audio data that may be divided into frames of a fixed duration. If the frames are 80 ms in duration, for example, the audio data may include eight stacked log Mel frames that span T_{frame}=10 ms each. Similarly, if the frames are 240 ms in duration, for example, and the audio data ends at 2180 ms, the audio data may include ten frames, rounded to the next frame. As shown in FIG. 5, the tokens 502-514 are spoken at particular times in the audio data. For example, token 502 starts at 140 ms and ends at 380 ms, token 504 starts at 460 ms and ends at 740 ms, and so on.

The alignment teacher may convert the utterance 500 (e.g., audio data) to a training sequence 516 (e.g., text data) that represents the moments in time in the utterance 500 at which a token 502-514 appeared (e.g., acoustic events). For a given set of training data 420, a token 502-514 (e.g., an event label) may be placed in the frame at which the token 502-514 begins or ends. Each frame may start with a BLANK symbol (e.g., a blank label), regardless of whether the frame includes a token 502-514 (e.g., an event label).

For example, as shown in FIG. 5, the training sequence 516 may include ten frames 518-536, each of which represents 240 ms in the 2180 ms of audio data corresponding to the utterance 500. Each frame 518-536 includes (e.g., starts with) a BLANK symbol (e.g., a label denoted as “_” but may be any other symbol) to signify that it is a distinct frame representing 240 ms of audio data. Because no tokens 502-514 occurred in the first 240 ms of the utterance 500, the first frame 518 may only include “_”. The second frame 520 may include “_and” because the “_” denotes the next frame, and “and” ended at 380 ms, which is within the second frame 520 between 240 ms and 480 ms. The third frame 522 may only include the “_” because no token 502-514 ended in the third frame 522 between 480 ms and 720 ms. The fourth frame 524 may include “_hand it” because the “_” denotes the next frame, and both “hand” and “it” end before the end of the fourth frame 524 at 960 ms. The fifth frame 526 may include “_over” because the “_” denotes the next frame and “over” ends within the fifth frame 526 between 960 ms and 1200 ms. The sixth frame 528 may include “_to” because the “_” denotes the next frame and “to” ends before the end of the sixth frame 528 at 1440 ms. The seventh frame 530 may only include the “_” because no token 502-514 ended within the seventh frame 530 between 1440 ms and 1680 ms. The eighth frame 532 may include “_to” because the “__” denotes the next frame and “to” ends within the eighth frame 532 between 1680 ms and 1920 ms. The ninth frame 534 may only include the “_” because no token 502-514 ended within the ninth frame 534 between 1920 ms and 2160 ms. The tenth frame 536 may only include the “_” because no token 502-514 ended within the tenth frame 536 between 2160 ms and 2400 ms. As discussed above, in some examples, the training sequence 516 may alternatively include a set of frames, each of which represents 80 ms in the audio data corresponding to the utterance 500.

From the training sequence 516, the embedding sequence 538 may be derived for input to the machine learning model 410 (e.g., an LLM decoder). Deriving the embedding sequence 538 from the training sequence 516 may include embedding each token (e.g., word or sub-word) label, while for each BLANK, the audio embedding for the corresponding time may be used. For example, the training sequence 516 may be “__ and _ hand it _ over __ to __ you __ EOS”, where “EOS” is a symbol representing the end of the sequence. The training sequence 516 may be transformed into an embedding sequence 538 at the input of the LLM decoder into “BOS f₁ f₂ and f₃ f₄ hand it f₅ over f₆ to f₇ f₈ you f₉ f₁₀ EOS” where “BOS” is a symbol representing the beginning of the sequence, “EOS” is a symbol representing the ending of the sequence, and fₙ may be the embedded audio frames representing the acoustic context.

With the training sequences 516 and interleaved speech/word-token embeddings (e.g., embedding sequence 538), the machine learning model 410 (e.g., an LLM decoder) may be trained for ASR (e.g., trained end-to-end with cross-entropy (CE) loss). The machine learning model 410 may iteratively process the embedding sequences 538, optimizing the parameters of the machine learning model 410 to minimize the loss (e.g., CE loss). The loss function (e.g., CE loss function) may measure the discrepancy between the predicted outputs and the actual target sequences (e.g., training sequence 516). By iterating over the time-aligned interleaved embedding sequences (e.g., embedding sequence 538), the machine learning model 410 may learn to integrate both linguistic and acoustic information dynamically.

Additional techniques, such as providing future context acoustically in the streaming encoder, may further enhance the ability of the machine learning model 410 to predict accurate outputs based on partial inputs. The training process thus refines the capacity of the machine learning model 410 to process real-time streaming data, enabling it to generate immediate and accurate responses, ultimately tailoring the machine learning model 410 (e.g., a pre-trained LLM) specifically for the task of real-time ASR.

In some embodiments, additional context may be provided to the machine learning model 410 before the machine learning model 410 generates a prediction. For example, the machine learning model 410 may predict an output token at a delay of two frames (e.g., 480 ms), giving the machine learning model 410 access to two future labels.

It should be noted that other applications aside from ASR are contemplated. The present disclosure may be applied to any LLM that may generate outputs proactively, rather than reactively. For example, the present disclosure may be applied to chat bots for chat bots to engage in natural dialogue with the user, allowing the chat bot to interject, pause, or otherwise time its output (e.g., control its flow of speech).

The present disclosure may also be applied to other (e.g., non-speech) modalities. For example, for real-time video analysis, the machine learning model 410 (e.g., an LLM) may be trained (e.g., fine-tuned) on labeled video frames to detect and describe events as they occur, such as identifying actions in surveillance footage or recognizing activities in sports broadcasts. For health monitoring applications, the machine learning model 410 (e.g., an LLM) may be trained (e.g., fine-tuned) on sensor data from wearable devices, with labels indicating health events (e.g., states or anomalies), allowing the machine learning model 410 to provide real-time feedback and alerts based on continuous sensor readings. For applications like home security, the machine learning model 410 (e.g., an LLM) may be trained (e.g., fine-tuned) on audio data with labels for specific environmental sounds (e.g., breaking glass, alarms) to provide real-time notifications of notable acoustic events. By adapting the training (e.g., fine-tuning) process to handle different types of streaming data, the machine learning model 410 may be effectively utilized across a wide range of real-time applications in addition to or instead of ASR, leveraging its architecture to provide immediate and accurate responses to dynamic inputs.

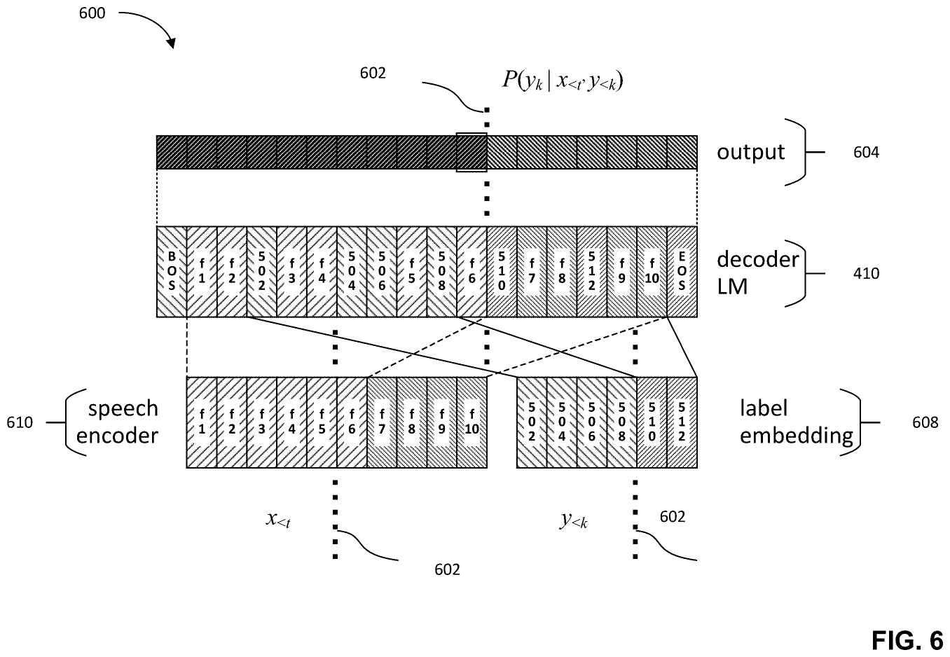

FIG. 6 illustrates an example architecture 600 to process speech and token embeddings, in accordance with an example of the present disclosure. FIG. 6 demonstrates a streaming LLM (to perform tasks such as ASR) which may be implemented by a streaming processing component (e.g., streaming processing component 47, streaming processing component 98) of a communication device (e.g., UE 30, computing system 30). The LLM implemented by the streaming processing component may continuously process incoming speech data and generate corresponding text in real-time. The speech encoder 610 may process the audio input into a form that the machine learning model 410 may use (e.g., embedding sequence 538), and the machine learning model 410 may use the information (e.g., embedding sequence 538) along with the previously generated (e.g., predicted) tokens to generate (e.g., predict) the next token (e.g., word or sub-word) in the sequence. This approach may enable real-time transcription of speech by generating text as the speech is being spoken, rather than waiting for complete utterances or regenerating the tokens as new data is received.

As shown in FIG. 6, the speech and text (e.g., words and/or sub-words) embeddings may be sequentially interleaved. Rather than providing the machine learning model 410 all speech and/or text data in advance before the machine learning model 410 may output the first token, the machine learning model 410 may receive speech and/or text data in a streaming manner (e.g., frame-by-frame) and emit (e.g., output) tokens as speech and/or text data is received. The machine learning model 410 may be an LLM (e.g., a decoder language model (LM)) trained to output text in an autoregressive manner, meaning that it predicts each subsequent token (e.g., word or sub-word) conditioned on the previous context (e.g., preceding tokens) until a special end of sequence symbol is generated (e.g., predicted).

The speech encoder 610 (e.g., a multi-modal encoder) may process the incoming speech data and generate a sequence of encoded speech vectors, denoted as x_{<t}. The encoded speech vectors represent the acoustic features of the speech data up to time t.

The label embeddings 608 may be the tokens that have been generated up to the current decoding step k (603), denoted as y_{<k}. The label embeddings 608 provide the linguistic context for the machine learning model 410 to generate the next token.

The machine learning model 410 may be an LLM, such as a decoder LLM. The encoded speech vectors generated by the speech encoder 610 may be fed into the machine learning model 410. The machine learning model 410 may also take in the previous label embeddings 608 to maintain linguistic context. For each decoding step k, the machine learning model 410 generates (e.g., predicts) the next token yₖ given the encoded audio data (from x_{<t}) and the linguistic context (from y_{<k}).

The output of the machine learning model 410 is denoted as P(yₖ|x_{<t}, y_{<k}), indicating the probability distribution over the possible next tokens, representing words or sub-words. From this distribution, the machine learning model 410 may select the token yₖ with the highest probability (e.g., greedy decoding) or based on other strategies such as by considering multiple high-probability tokens (e.g., beam search). The selected token yₖ may then be output by the machine learning model 410, which may be added to the sequence of output tokens 604. In some instances, the selected token yₖ may be a BLANK token (e.g., a “_” symbol or nothing), indicating that more speech data is needed to output a word or sub-word token.

The operation of the machine learning model 410 may be illustrated by the following greedy inference algorithm/application:

| | |
|---|---|
| 1: | h ← [EMBED TOKEN(BOS)] |
| 2: | while e ←AWAIT & EMBED NEXT REAL-TIME INPUT do |
| 3: | h.ADD(e) |
| 4: | while w ←PREDICT TOKEN(h), w ≠ BLANK do |
| 5: | h.ADD(EMBED TOKEN(w)) |
| 6: | h.ADD(EMBED TOKEN(EOS)) |
| 7: | while w ←PREDICT TOKEN(h), w ≠ EOS do |
| 8: | h.ADD(EMBED TOKEN(w)) |

The algorithm/application may process speech input one embedding vector e at a time, where in a real-time setting, line 2 may block until sufficient additional audio data has been received to produce the next embedding vector. As one non-limiting example, an input embedding may be generated every 80 ms of audio. As another non-limiting example, an input embedding may be generated every 240 ms of audio.

Each time a speech embedding has been received, the received speech embedding may be added to the LLM history h. Unlike other (non-real-time) LLM decoding, however, text generation may be performed immediately (e.g., greedy inference algorithm/application line 4) until a BLANK symbol has been predicted. When no new words were received (e.g., words ending in the received speech embedding), the machine learning model 410 may immediately predict a BLANK symbol, ending the loop right away.

The first five lines of the greedy inference algorithm/application may be sufficient to stream transcription of a continuous audio stream in real time; but to decode audio files, the machine learning model 410 may emit additional trailing tokens at the end (e.g., greedy inference algorithm/application line 6). The end of speech input is communicated to the decoder as an EOS embedding.

Referring still to FIG. 6 and using the example utterance 500 as an example, the machine learning model 410 may operate by generating tokens in an autoregressive manner, leveraging both the encoded speech input from the speech encoder 610 and the label embeddings 608 (e.g., previously generated tokens) to predict the next token in the sequence (e.g., output 604). The process begins with the speech encoder 610, which continuously processes the utterance 500 as it arrives and generates a series of encoded vectors (e.g., f₁ through f₁₀) representing the acoustic features of the speech data up to the current time 602.

The state of the machine learning model 410 starts with a special beginning of sequence (BOS) symbol, initiating the text generation process. Using the encoded speech vectors x_{<t} from the speech encoder 610 and the initial BOS token, the machine learning model 410 may predict the first token 502 (y₁). This prediction may be based on the probability distribution P(y₁|x, BOS), for example, by selecting the token with the highest probability. Once the first token 502 is generated, the first token 502 may be fed back into the machine learning model 410 as part of the sequence of label embeddings 608, now denoted as y_{<2}. In some embodiments, a BLANK symbol may not be fed back into the machine learning model 410 as part of the sequence of label embeddings 608.

The process may then iterate. At each subsequent step k, the machine learning model 410 may use the encoded speech vectors (x_{<t}) and the previously generated tokens (y_{<k}) to predict the next token (yₖ). Specifically, the machine learning model 410 may calculate the probability distribution P(yₖ|x_{<t}, y_{<k}) and select the most likely token based on the probability distribution (e.g., the token with the highest probability). The selected token may then be appended to the sequence of generated tokens (output 604) unless it is a BLANK symbol.

For example, as shown in FIG. 6, at step t=6, the encoded speech vector associated with frame f₆ may be provided to the machine learning model 410 by the speech encoder 610. Using the encoded speech vectors x_{<6} from the speech encoder 610 and the initial BOS token, the machine learning model 410 may predict the fifth token 510 (y₅) at decoding step five (603). This prediction may be based on the probability distribution P(y₅|x_{<5}, y_{<4}), for example, by selecting the token with the highest probability. Once the fifth token 510 is generated as part of output 604, the fifth token 510 may be fed back into the machine learning model 410 as part of the sequence of label embeddings 608, now denoted as y_{<5}. The machine learning model 410 may continue the loop, processing new speech input in real-time and updating the sequence of tokens (e.g., output 604 and/or label embeddings 608) with each new prediction. The process may continue until an EOS token is predicted, signaling the end of the transcription.

As demonstrated by the foregoing detailed description, the present disclosure offers several advantages over current LLMs including, for example, the machine learning model 410 may output tokens on a streaming basis (e.g., without first receiving the entire input) without explicit end-pointing, the machine learning model 410 may be fine-tuned to learn and reproduce the flow of time (e.g., via the outputting of BLANK symbols to control the flow of the output), and the machine learning model 410 may process inputs of one or more modalities (e.g., text, video, audio).

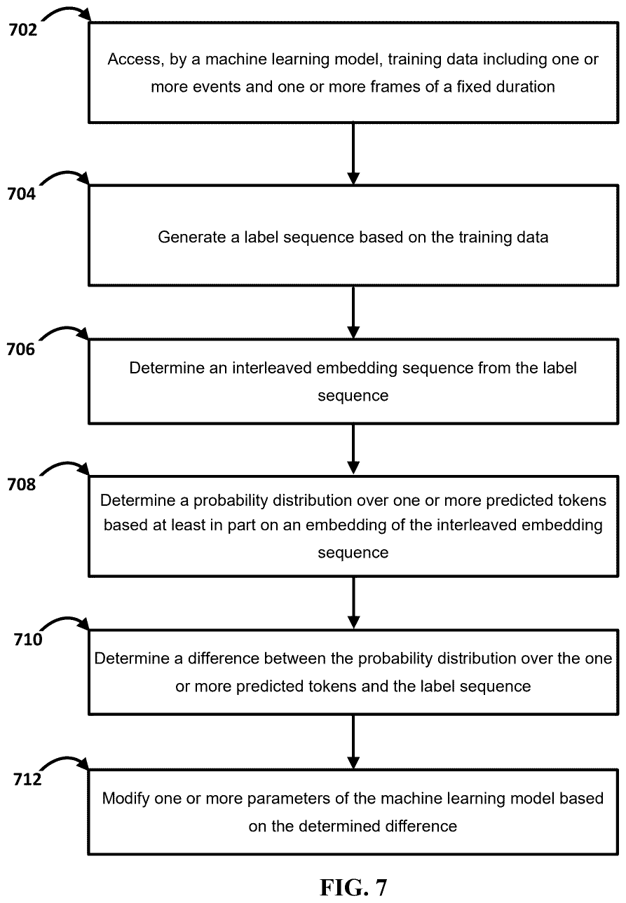

FIG. 7 illustrates an example flowchart illustrating operations associated with the machine learning processing of streaming training data according to an example of the present disclosure. At operation 702, a device (e.g., UE 30, computing system 300) may access, by a machine learning model (e.g., machine learning model 410), training data (e.g., training data 420). The training data may include one or more events (e.g., speech) and one or more frames (e.g., one or more of frames 518-536) of a fixed duration.

At operation 704, a device (e.g., UE 30, computing system 300) may utilize a machine learning model (e.g., machine learning model 410) that generates a label sequence (e.g., training sequence 516) based on the training data. In some examples, the machine learning model may generate the label sequence by associating an input condition with the one or more events. The machine learning model may further generate a label (e.g., one or more of tokens 502-514) based on the input condition. In some examples, the machine learning model may generate the label by detecting one or more tokens representing words or sub-words in the training data. The machine learning model may further associate the one or more frames with the label. In some examples, the machine learning model may associate a frame with a label by detecting a time period corresponding to an appearance of the label in an utterance including the training data and may place the label in the frame during a period corresponding to a time of the appearance of the label in the utterance or a time close to the appearance of the label in the utterance. In some examples, a label may be placed in a frame following a BLANK symbol, which may include a period of events including silence, in the training data.

At operation 706, a device (e.g., UE 30, computing system 300) may utilize a machine learning model (e.g., machine learning model 410) that determines/derives an interleaved embedding sequence (e.g., embedding sequence 538) from the label sequence. In some examples, the machine learning model may embed the label sequence by transforming the label sequence into symbols corresponding to a beginning of the label sequence (e.g., BOS), an end of the label sequence (e.g., EOS), and the one or more frames.

At operation 708, a device (e.g., UE 30, computing system 300) may utilize a machine learning model (e.g., machine learning model 410) that determines a probability distribution over one or more predicted tokens based at least in part on an embedding of the interleaved embedding sequence. In some examples, the machine learning model may determine the probability distribution by determining a probability distribution of an encoded vector associated with the one or more events in the training data, a respective number of blank symbols corresponding to a period between the one or more events in the training data, and a target output in the label sequence. In some examples, the machine learning model may further select the predicted token based on the probability distribution.

At operation 710, a device (e.g., UE 30, computing system 300) may utilize a machine learning model (e.g., machine learning model 410) that determines a difference between the probability distribution over the one or more predicted tokens and the label sequence. In some examples, the machine learning model may determine/calculate a gradient of a loss function that measures a prediction error of the machine learning model with respect to one or more parameters.

At operation 712, a device (e.g., UE 30, computing system 300) may utilize a machine learning model (e.g., machine learning model 410) that modifies one or more parameters based on the determined difference between the predicted token and the label sequence. In some examples, the machine learning model may adjust one or more parameters utilizing a gradient that reduces a prediction error.

### Alternative Embodiments

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of applications and symbolic representations of operations on information. These application descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as components, without loss of generality. The described operations and their associated components may be embodied in software, firmware, hardware, or any combinations thereof.

Any of the steps, operations, or processes described herein may be performed or implemented with one or more hardware or software components, alone or in combination with other devices. In one embodiment, a software component is implemented with a computer program product comprising a computer-readable medium containing computer program code, which can be executed by a computer processor for performing any or all of the steps, operations, or processes described.

Embodiments also may relate to an apparatus for performing the operations herein. This apparatus may be specially constructed for the required purposes, and/or it may comprise a computing device selectively activated or reconfigured by a computer program stored in the computer. Such a computer program may be stored in a non-transitory, tangible computer-readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments also may relate to a product that is produced by a computing process described herein. Such a product may comprise information resulting from a computing process, where the information is stored on a non-transitory, tangible computer-readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed:

1. A method, comprising:
accessing, by a machine learning model, training data including one or more events and one or more frames of a fixed duration;
generating a label sequence based on the training data;
determining an interleaved embedding sequence from the label sequence;
determining a probability distribution over one or more predicted tokens based at least in part on an embedding of the interleaved embedding sequence;
determining a difference between the probability distribution over the one or more predicted tokens and the label sequence; and
modifying one or more parameters of the machine learning model based on the determined difference.

2. The method of claim 1, wherein the generating the label sequence based on the training data comprises:
associating an input condition with the one or more events;
generating a label based on the input condition; and
associating the one or more frames with the label.

3. The method of claim 2, wherein the generating the label based on the input condition comprises detecting one or more tokens representing at least one of words and sub-words in the training data.

4. The method of claim 2, wherein the associating the one or more frames with the label comprises:
determining a time corresponding to an appearance of the label in an utterance comprising the training data; and
placing the label in the one or more frames during a period corresponding to at least one of the time of the appearance of the label in the utterance or a time close to the appearance of the label in the utterance.

5. The method of claim 4, wherein the placing the label in the one or more frames at the time corresponding to the appearance of the label in the utterance comprises:
determining a blank symbol corresponding to a period between the one or more events in the training data; and
placing the label in the one or more frames following the blank symbol.

6. The method of claim 1, wherein the determining the interleaved embedding sequence from the label sequence comprises transforming the label sequence into a plurality of symbols corresponding to a beginning of the label sequence, an end of the label sequence, and the one or more frames.

7. The method of claim 1, wherein the determining the probability distribution over the one or more predicted tokens based at least in part on the embedding of the interleaved embedding sequence comprises:
determining a probability distribution of an encoded vector associated with the one or more events, a respective number of blank symbols corresponding to a period between the one or more events in the training data, and a target output in the label sequence; and
selecting the predicted token based on the probability distribution.

8. The method of claim 1, wherein the determining the difference between the probability distribution over the one or more predicted tokens and the label sequence comprises determining a gradient of a loss function that measures a prediction error of the machine learning model with respect to the one or more parameters.

9. The method of claim 1, wherein the modifying the one or more parameters of the large language model based on the determined difference comprises adjusting the one or more parameters utilizing at least one gradient that reduces a prediction error of the machine learning model.

10. An apparatus comprising:
one or more processors; and
at least one memory storing instructions, that when executed by the one or more processors, cause the apparatus to:
access, by a machine learning model, training data including one or more events and one or more frames of a fixed duration;
generate a label sequence based on the training data;
determine an interleaved embedding sequence from the label sequence;
determine a probability distribution over one or more predicted tokens based at least in part on an embedding of the interleaved embedding sequence;
determine a difference between the probability distribution over the one or more predicted tokens and the label sequence; and
modify one or more parameters of the machine learning model based on the determined difference.

11. The apparatus of claim 10, wherein when the one or more processors execute the instructions to generate the label sequence, the apparatus is further configured to:
associate an input condition with the one or more events;
generate a label based on the input condition; and
associate the one or more frames with the label.

12. The apparatus of claim 11, wherein when the one or more processors execute the instructions to generate the label based on the input condition, the apparatus is further configured to detect one or more tokens representing at least one of words and sub-words in the training data.

13. The apparatus of claim 11, wherein when the one or more processors execute the instructions to associate the one or more frames with the label, the apparatus is further configured to:
detect a time corresponding to an appearance of the label in an utterance comprising the training data; and
place the label in the one or more frames at the time corresponding to an appearance of the label in the utterance.

14. The apparatus of claim 13, wherein when the one or more processors execute the instructions to place the label in the one or more frames at the time corresponding to the appearance of the label in the utterance, the apparatus is further configured to:
detect a blank symbol corresponding to a period between the one or more events in the training data; and
place the label in the one or more frames during a period corresponding to at least one of the time of the appearance of the label in the utterance or a time close to the appearance of the label in the utterance.

15. The apparatus of claim 10, wherein when the one or more processors execute the instructions to derive the interleaved embedding sequence from the label sequence, the apparatus is further configured to transform the label sequence into a plurality of symbols corresponding to a beginning of the label sequence, an end of the label sequence, and the one or more frames.

16. The apparatus of claim 10, wherein when the one or more processors execute the instructions to determine the probability distribution over the one or more predicted tokens based at least in part on the embedding of the interleaved embedding sequence, the apparatus is further configured to:
determine a probability distribution of an encoded vector associated with the one or more events, a respective number of blank symbols corresponding to a period between the one or more events in the training data, and a target output in the label sequence; and
select the predicted token based on the probability distribution.

17. The apparatus of claim 10, wherein when the one or more processors execute the instructions to determine a difference between the probability distribution over the one or more predicted tokens and the label sequence, the apparatus is further configured to calculate a gradient of a loss function that measures a prediction error of the machine learning model with respect to the one or more parameters.

18. The apparatus of claim 10, wherein when the one or more processors execute the instructions to modify one or more parameters of the large language model based on the determined difference, the apparatus if further configured to adjust the one or more parameters utilizing at least one gradient that reduces a prediction error of the machine learning model.

19. A non-transitory computer-readable medium storing instructions that, when executed, cause:
accessing, by a machine learning model, training data including one or more events and one or more frames of a fixed duration;
generating a label sequence based on the training data;
determining an interleaved embedding sequence from the label sequence;
determining a probability distribution over one or more predicted tokens based at least in part on an embedding of the interleaved embedding sequence; and
determining a difference between the probability distribution over the one or more predicted tokens and the label sequence; and
modifying one or more parameters of the machine learning model based on the determined difference.

20. The non-transitory computer-readable medium of claim 19, wherein the instructions generating the label sequence based on the training data, when executed, further cause:
associating an input condition with the one or more events;
generating a label based on the input condition; and
associating the one or more frames with the label.
